(19) United States
(12) Patent Application Publication
(10) Pub. No.: US 2009/0231853 A1
(43) Pub. Date: Sep. 17, 2009

(54) SURGICAL LIGHT

(75) Inventors: Manfred Scholz, Seitingen-Oberflacht (DE); Michael Mueller, Worndorf (DE)

Correspondence Address: LEWIS AND ROCA LLP, 1663 Hwy 395, Suite 201, Minden, NV, 89423, US

(73) Assignee: Berchtold Holding GmbH, Tuttlingen (DE)

(21) Appl. No.: 12/402,926

(22) Filed: Mar. 12, 2009

(30) Foreign Application Priority Data
Mar. 13, 2008 (DE) 10 2008 014 128.3

(51) Int. Cl. F21V 11/02

(52) U.S. Cl. 362/291

(57) ABSTRACT

The invention relates to a surgical light having at least one discharge lamp which is arranged in a lamp body and which illuminates a surgical field via a reflector, wherein a mechanically adjustable diaphragm means is provided in the lamp body for changing the intensity of illumination and includes a plurality of lamellae which are pivotable about a vertical axis and which have a light impermeable material with cut-outs.

### CROSS-REFERENCE TO RELATED APPLICATIONS

This application claims priority to co-pending German Patent Application Serial Number 10 2008 014 128.3, filed 13 Mar. 2008, the entirety of which is incorporated by reference herein.

### BACKGROUND OF THE INVENTION

### Field of the Invention

The present invention relates to a surgical light in accordance with the preamble of claim 1. Such a surgical light is known from DE 101 51 978.

Such known surgical lights having a discharge lamp have proven themselves in practice since the desired intensities of illumination can be provided without the environment being excessively heated. Since discharge lamps cannot be dimmed electrically in a conventional manner, pivotable lamellae are provided for the dimming of the light incident onto the surgical field with whose help the light discharge can be shaded. In this respect, the lamellae are produced from light impermeable material and have cut-outs to limit a maximum dimming of the lamp to a value of 30%, for example.

On the carrying out of endoscopic or laparoscopic operations, an intensity of illumination in the order of magnitude of 30 to 50 klx is required for the preparation of the operation. However, only an orientation light is required for the endoscopic procedure itself. If, however, complications should arise in an endoscopic procedure, the procedure is aborted immediately under certain circumstances and the full intensity of illumination of up to 160 klx is required without time delay for open surgery.

### BRIEF DESCRIPTION OF THE INVENTION

It is the object of the present invention to improve a surgical light of the initially named kind such that it can also be used in endoscopic procedures.

This object is satisfied by the features of claim 1 and in particular in that a light impermeable closure element is provided at least one lamella with which the cut-outs of the lamella can be closed. The intensity of illumination of the surgical light can be further reduced in this manner for an endoscopic intervention without the discharge lamp having to be fully switched off; that is the surgical light is available for emergency operation with full intensity of illumination at all times. By providing closure elements at a plurality of lamellae or at all lamellae, the residual light output by the surgical light with closed lamellae can be reduced so far that only straying scattered light is output by the surgical light which is, however, desirable for an endoscopic procedure. Since the surgical light can be operated at an increased intensity of illumination at any time by opening the closure elements and optionally also the lamellae, there is also no risk for the patent in the event of an emergency procedure since the discharge lamp is not switched off and thus also a few minutes do not pass until it can be restarted again.

Advantageous embodiments of the invention are described in the description, in the drawing and in the dependent claims.

In accordance with a first advantageous embodiment, the closure element can be provided with openings which correspond to the cut-outs of the lamella. The closure element can in this manner either be aligned with the lamella so that the cut-outs and the openings are aligned so that no shading is caused by the closure element. On the other hand, the closure element can be positioned in front of the lamella so that no light can exit through the cut-outs of the lamella.

In accordance with a further advantageous embodiment of the invention, a lamella can have two rows of spaced apart cut-outs of a rectangular shape. A much improved light distribution is hereby achieved in comparison with throughgoing slots or openings and a more uniform light field is thus achieved if the lamellae are in the closed state and the closure elements are in the open state.

In accordance with a further advantageous embodiment, a closure element is provided at all lamellae, with all the closure elements being able to be actuated via a common drive. In this manner, the residual light exiting the surgical light can be reduced to approximately 1% with closed lamellae and closed closure elements. Such a residual light is well suited for endoscopic procedures since the present residual light brightens the operating room just sufficiently so that an additional auxiliary light for endoscopic procedures, such as is known from the prior art with surgical lights, can even be dispensed with.

The lamellae can be pivoted into a closed position using the surgical light in accordance with the invention so that a residual light portion of, for example, approximately 50% to approximately 30% exits the surgical light with non-closed cut-outs. Good results have been achieved with a residual light portion in an order of magnitude of approximately 30%. If subsequently, with lamellae pivoted completely into the closed position, the cut-outs are fully closed by the closure elements, a residual light portion in an order of magnitude of approximately 5%, in particular of approximately 3% to approximately 1%, can be achieved. Good results have been achieved in practice in that a residual light portion in an order of magnitude of some few percent, for example 1%, exits when both the lamellae and also the closure elements are completely closed. It is, however, also simultaneously advantageous if a residual light portion of at least approximately 1% is ensured since such a residual light portion is desired for endoscopic procedures.

So that no unwanted shading takes place by the closure element, in accordance with a further advantageous embodiment, a drive can be provided which only actuates the closure element with a completely closed lamella.

A cost-effective manufacture of the surgical light can be achieved in that only one single drive, for example, one single electric motor, is provided for the movement of the lamellae, on the one hand, and for a movement of the closure element, on the other hand.

In accordance with a further advantageous embodiment, the closure element can be movable along the pivot axis of the lamellae. A compact construction and a problem-free operation hereby result.

In accordance with a further advantageous embodiment, a rotatably journaled guide element can be provided for a movement of the lamellae and of the closure element which first effects a pivot movement of the lamellae and subsequently a stroke movement of the closure element. A purely mechanical dimming device is hereby provided with which not only the lamellae can be opened and closed, but also the closure elements can be activated once the lamellae are located in their completely closed position.

In accordance with a further advantageous embodiment, a blocking device can be provided which prevents an activation or actuation of the closure element when the lamellae are not located in a completely closed position. Such a blocking device, which can be formed mechanically or also electronically or by means of software, prevents an accidental shading by the closure element when the lamellae are not yet completely closed.

### BRIEF DESCRIPTION OF THE DRAWING FIGURES

The present invention will be described in the following purely by way of example with reference to an advantageous embodiment and to the enclosed drawings. There are shown:

FIG. 1 a sectional view of a surgical light;

FIG. 2 a perspective representation of the diaphragm means with opened lamellae and opened closure elements; and

FIG. 3 a plan view from below of a cam guide of the diaphragm means of FIG. 2.

### DETAILED DESCRIPTION OF THE INVENTION

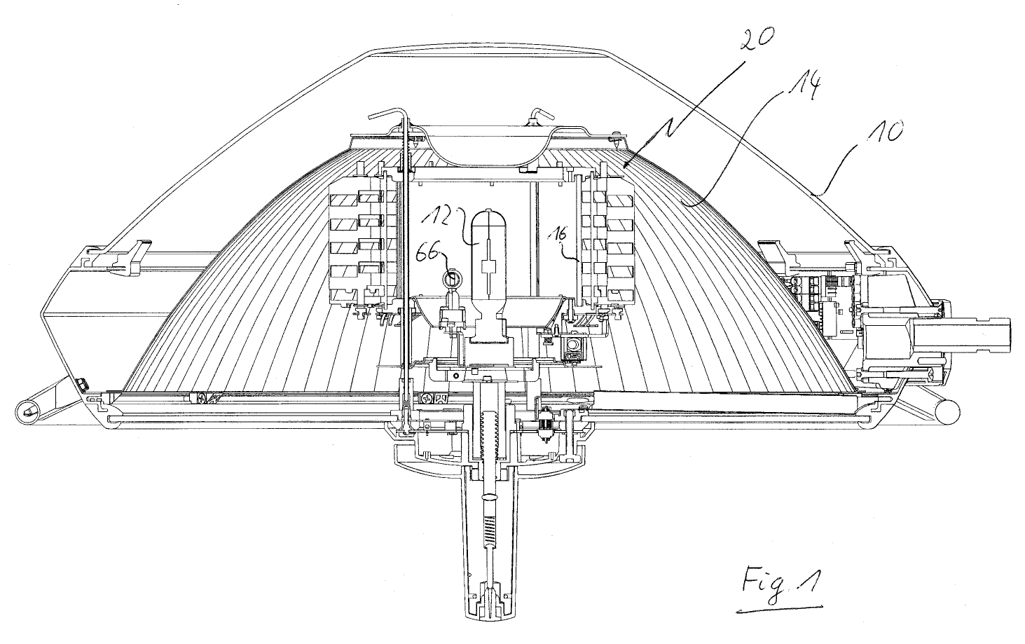

FIG. 1 shows a sectional view of a surgical light having a lamp body 10 in which a discharge lamp 12 is arranged which illuminates a surgical field via a paraboloid reflector 14. The discharge lamp 12 has an approximately cylindrical design and is arranged vertically along the central axis of the surgical light. The light exiting the discharge lamp 12 initially radiates through a hollow cylindrical glass filter 16 and is then incident onto the reflector 14 which guides the light onto the surgical site without shade.

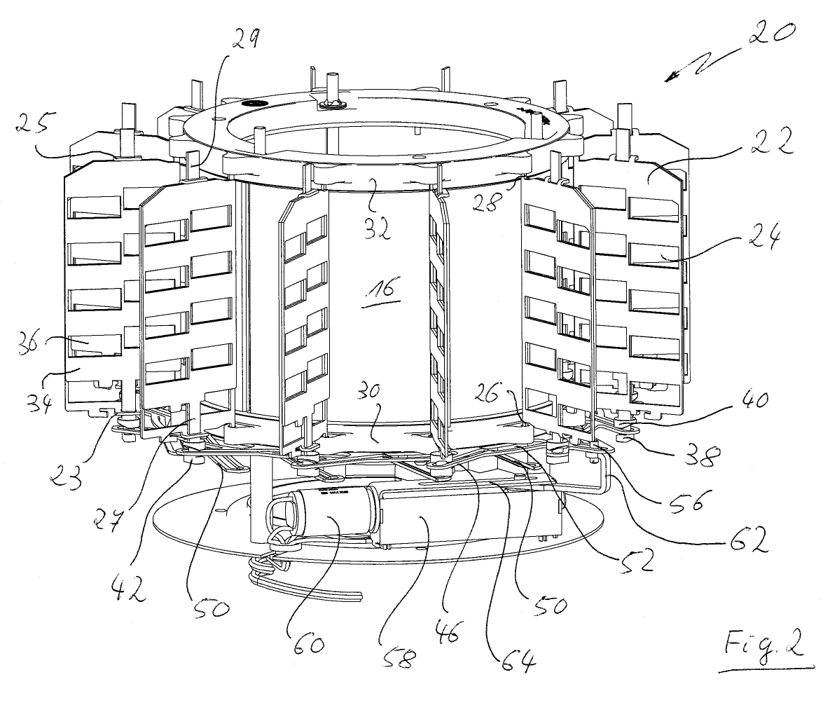

A mechanically adjustable diaphragm means 20 is provided for the adjustment of the intensity of illumination of the light exiting the surgical light; it is shown magnified in FIG. 2 and includes in the embodiment shown a total of twelve approximately rectangular lamellae 22 which are each pivotable around a vertical axis. The lamellae 22 comprise light impermeable material, for example, stamped sheet metal and have a plurality of cut-outs 24. In the embodiment shown, two rows of spaced part cut-outs 24 are provided arranged next to one another per lamella 22, with five cut-outs of rectangular shape being provided in each row and the cut-outs of the inner row and of the outer row being of equal size. The cut-outs of the inner row and of the outer row are furthermore arranged slightly mutually offset so that the upper margin of the outer cut-outs 24 is located approximately at the center of the inner cut-outs.

The lamellae 22 have a lower spigot 26 and an upper spigot 28 at their radially inner sides, with the lower spigots 26 being set into a lower support ring 30 and the upper spigots 28 being set into an upper support ring 32 so that the lamellae 22 are pivotable around the spigots 26 and 28, that is around a vertical pivot axis.

In the embodiment shown, each lamella 22 is furthermore provided with a light impermeable closure element 34 which has approximately the same outer contour as the associated lamellae and which contacts the respective associated lamella in planar fashion. Each closure element 34 has openings 36 whose size and arrangement correspond to the cut-outs 24 of the lamellae 22. However, the closure elements 34 have only four openings 36 in a row, whereas the lamellae 22 are provided with a total of five cut-outs 24 lying above one another. The closure elements are in turn somewhat shorter than the lamellae.

As FIG. 2 shows, each lamella 22 has an angled over lower lug 23 at its lower side and an angled over upper lug 25 at its upper side. Respective strip sections 27 and 29 of the associated closure element are guided by these two lugs 23 and 25 so that the closure element 34 can be moved relative to the lamella 22 along the pivot axis of the lamella, that is upwardly and downwardly in FIG. 2. In the position shown in FIG. 2, all lamellae 22 are in their completely open position in which they are aligned substantially radially and do not block a light exit. At the same time, the closure elements 34 are in their open position in which the openings 36 of the closure elements 34 are aligned with the cut-outs 24 of the lamellae 22. The two bottommost openings 24 of each lamella are not covered by the respective closure element 34.

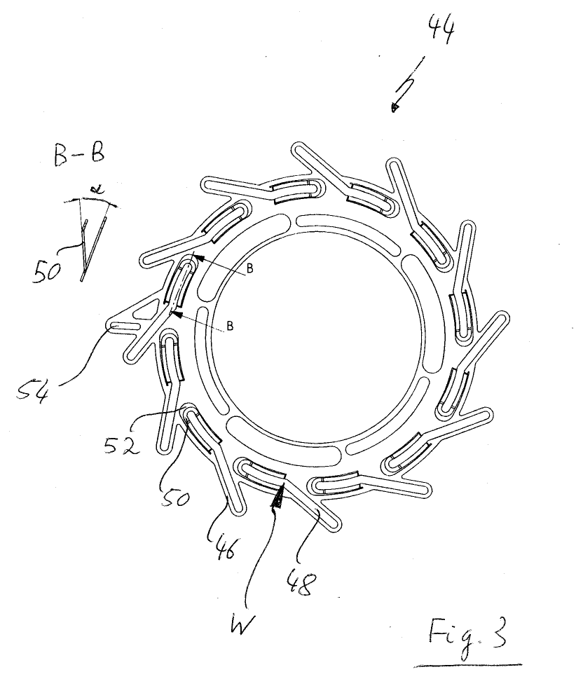

As FIG. 2 further illustrates, a guide button 38 of plastic in molded to each lower strip section 27 of each closure element 34, said guide button having an approximately circular-cylindrical upper section 40 and an approximately parallelepiped shaped lower section 42. The guide button 38 serves for the pivoting of the lamellae 22 and for the opening and closing of the closure elements 34 with the help of a cam ring 44 which is shown in FIG. 3.

The cam ring 44 shown in FIG. 3 is stamped from sheet steel and has a ring section from which a total of twelve web sections 46 extend radially outwardly at an angle of approximately 30° and each form an inner guide slot 48. Each guide slot 48 extends from the radially outer end of the web sections 46 in linear fashion up to a radially inwardly disposed turning point W from which the slot 48 extends in the peripheral direction. In this respect, a U-shaped tongue 50 surrounding the slot 48 is stamped out of the cam ring 44 in the section of the slot 48 extending from the turning point W and is angled downwardly at an angle of approximately 30° as shown in the representation B-B. The guide button 38 can hereby slide on the web section 46 from its radially outer end up to the turning point W. If the guide button 38 is moved further within the slot 48, it slides, from the turning point W onward, on the tongue 50 downwardly through the cut-out 52 formed by the tongue 50.

To be able to rotate the cam ring 44 around the center axis of the surgical light and relative to the support rings 30 and 32, a cut-out having an elongate hole 54 into which a spigot 56 engages which is fastened to a drive 58 is provided at the cam ring 44 in the region of a web section 46. The drive 58 has an electric motor 60 which moves a spindle (not shown) so that a holding arm 62 to which the spigot 56 is fastened can be moved to and fro along a linear guide 64.

The operation of the mechanical diaphragm means 20 is as follows:

FIG. 2 shows the mechanical diaphragm means 20 in the completely open position in which all lamellae 22 are aligned substantially radially and in which the closure elements 22 are located in their open position in which the cut-outs 24 of the lamellae are not covered. If a dimming of the surgical light is desired, the electric motor 60 is activated so that the holding arm 62 in FIG. 2 moves to the left along the linear guide 64, whereby the cam ring 44 is pivoted to the left, that is clockwise, whereas the spigot 56 slides in the elongate hole 54. In this movement, the guide buttons 38 slide in the guide slots 48 so that the lamellae 22 are pivoted around their vertical pivot axis and close. The lamellae 22 can be pivoted so far by a further rotation of the cam ring 44 so that they are completely closed, that is until the guide button 38 has reached the turning point W. All the lamellae 22 are admittedly closed in this state, but a residual light portion of approximately 30% can exit through the cut-outs 24 and through the openings 36 of the closure elements 34.

If a still further darkening of the operating room is desired, but without switching off the discharge lamp 12, the electric motor 60 can be activated again so that the cam ring 44 continues to rotate clockwise. In this respect, the guide buttons 38 slide obliquely downwardly on the downwardly angled tongues 50 so that the closure elements 34 move downwardly relative to the lamellae 22 and thereby increasingly cover the cut-outs 24. When the guide buttons 38 have reached the end of the tongues 50, they are in their bottommost position in which all the cut-outs 24 are covered or closed by the closure element 34. in this state, only a straying scattered light portion of approximately 1% can exit the surgical light, which is, however, desired for an endoscopic procedure.

Once an endoscopic procedure has been ended or if an emergency operation is required, only the electric motor 60 has to be operated in the opposite direction so that initially the closure elements 34 move vertically upwardly and the lamellae 22 are subsequently pivoted into their open position shown in FIG. 2.

The reference numeral 66 in FIG. 1 designates a halogen lamp for emergency operation if the discharge lamp 12 or the power supply should go down.

We claim:

1. A surgical light having at least one discharge lamp which is arranged in a lamp body and which illuminates a surgical field via a reflector, wherein a mechanically adjustable diaphragm means is provided in the lamp body for changing the intensity of illumination and includes a plurality of lamellae which are pivotable about a vertical axis and which have a light impermeable material with cut-outs,
characterized in that
a light impermeable closure element is provided at least one lamella and the cut-outs of the lamella can be closed therewith.

2. A surgical light in accordance with claim 1, characterized in that the closure element is provided with openings which correspond to the cut-outs of the lamella.

3. A surgical light in accordance with claim 1, characterized in that a lamella has two rows of spaced apart cut-outs of rectangular shape.

4. A surgical light in accordance with claim 1, characterized in that a closure element is provided at all lamellae; and in that all closure elements can be actuated via a common drive.

5. A surgical light in accordance with claim 1, characterized in that a drive is provided which only actuates the closure element with a completely closed lamella.

6. A surgical light in accordance with claim 1, characterized in that a single drive, in particular a single electric motor is provided for the movement of the lamellae and for a movement of the closure element.

7. A surgical light in accordance with claim 1, characterized in that the closure element is displaceable along the pivot axis of the lamellae.

8. A surgical light in accordance with claim 1, characterized in that a rotatably journaled guide element is provided for a movement of the lamellae and of the closure element, said rotatably journaled guide element initially effecting a pivot movement of the lamellae on a rotation and subsequently effecting a stroke movement of the closure element.

9. A surgical light in accordance with claim 1, characterized in that a blocking device is provided which prevents an actuation of the closure element when the lamellae are not in a completely closed position.

10. A surgical light in accordance with claim 1, characterized in that a residual light portion of approximately 50% to approximately 30% exits the surgical light with lamellae completely pivoted into a closed position and unclosed cut-outs.

11. A surgical light in accordance with claim 1, characterized in that a residual light portion of at most approximately 5%, in particular of at most approximately 3% up to approximately 1%, exits the surgical light with lamellae completely pivoted into a closed position and completely closed cut-outs.

12. A surgical light in accordance with claim 1, characterized in that a residual light portion of at least approximately 1% exits the surgical light with lamellae completely pivoted into a closed position and completely closed cut-outs.
